(19) United States
(12) Patent Application Publication
(10) Pub. No.: US 2005/0216102 A1
(43) Pub. Date: Sep. 29, 2005

(54) Power supply circuit for physical quantity sensor

(76) Inventor: Yukihiko Tanizawa, Kariya-shi (JP)

Correspondence Address: POSZ LAW GROUP, PLC, 12040 SOUTH LAKES DRIVE, SUITE 101, RESTON, VA, 20191, US

(21) Appl. No.: 11/085,255

(22) Filed: Mar. 22, 2005

(30) Foreign Application Priority Data
Mar. 24, 2004 (JP) 2004-86820

(51) Int. Cl. G05B 13/02

(52) U.S. Cl. 700/28

(57) ABSTRACT

A physical quantity sensor comprises a sensor element, a signal processing circuit, and a power supply circuit. The sensor element senses a physical quantity to output a signal corresponding to the sensed physical quantity. The signal processing circuit processes the signal coming from the sensor element. The power supply circuit, which is in charge of powering the signal processing circuit, controls predetermined voltage provided from outside the sensor so that a total amount of both of power consumed by the power supply circuit and power consumed by the signal processing circuit is constant. Power-supply voltage subjected to the control to the signal processing circuit through a line connecting the power supply circuit and the signal processing circuit. By way of example, both the power supply circuit and the signal processing circuit are provided on the same semiconductor substrate.

### CROSS REFERENCES TO RELATED APPLICATION

The present application relates to and incorporates by reference Japanese Patent application No. 2004-86820 filed on Mar. 24, 2004.

### BACKGROUND OF THE INVENTION

1. Field of the Invention

The present invention relates to a power supply circuit which supplies driving power to a signal processing circuit in a physical quantity sensor.

2. Description of the Related Art

Physical quantity sensors have now been used in a variety of applications in the industry. One type of physical quantity sensors is, for example, an “infrared sensor,” which is disclosed in Japanese Patent Application Laid-open Publication No. 2003-270047. The “infrared sensor” disclosed in the publication No. 2003-270047 incorporates a sensor element for detecting infrared which is adhered via an adhesive on one surface of the circuit substrate to make possible a smaller sensor and lower cost. A gap portion is configured by not coating the adhesive on the entire circumference of the recessed portion formed in the sensor element and by providing a region in a portion of the circumference in which no adhesive is coated. The gap portion can thus communicate the space in the recessed portion and the outside to prevent the sealed space formed in the recessed portion. Even if, therefore, any heat is applied to the sensor element, the volumetric gas expansion in the relevant recessed portion can be prevented to avoid the damage of the sensor element due to the damage of the thin-walled portion (membrane portion) of the relevant recessed portion.

An output (hereinafter referred to as a “sensor output”) of the physical quantity sensor such as the “infrared sensor” disclosed in the publication No. 2003-270047 is usually subject to predetermined signal processing performed by a signal processing circuit. The relevant signal processing circuit may be formed on the same semiconductor substrate that has the physical quantity sensor thereon. Most of the physical quantity sensors are formed on a semiconductor substrate such as silicon, so that their sensor outputs may have temperature characteristics or have different characteristics for different production lots. To absorb such a variation in the characteristics of the sensor output, the relevant signal processing circuit includes, for example, an adjustment circuit such as the “trimming circuit in the physical quantity sensor,” which is disclosed in another Japanese Patent Application Laid-open Publication No. 2002-350256.

In an adjusting circuit such as the “trimming circuit in the physical quantity sensor” disclosed in the publication No. 2002-350256, however, the relevant signal processing circuit itself and its environment may have different temperatures between in trimming adjustment before shipping products and in sensor usage after shipping products. The temperature environment of the physical quantity sensor may also be different, particularly, as in the “infrared sensor” disclosed in the publication No. 2003-270047, in the case of the relevant physical quantity sensor (sensor element) being mounted on the substrate (circuit substrate) in which the signal processing circuit is formed. In this case, there is thus a technological problem in which the trimming adjustment before shipping products may not work effectively.

Specifically, with reference to the “trimming circuit in the physical quantity sensor” disclosed in the publication No. 2002-350256, the circuit includes, as a signal processing circuit, a logic circuit part, a trimming voltage control circuit part, and an analog circuit part. Each of the circuit parts to has different operating conditions, such as the operating positions, operating speeds, and operating times, between in trimming adjustment and in sensor usage. Between the two conditions, therefore, each of the circuit parts consumes different amounts of current, and each of the relevant circuit parts to generates different amounts of heat, so that the relevant signal processing circuit itself and its environment have different temperatures. Such a temperature difference may have an impact on the temperature characteristics of the relevant signal processing circuit as well as the physical quantity sensor. This may raise, therefore, the problem of so-called adjustment-deviation in that even if the characteristics-adjustment data is accurately measured for the trimming adjustment in the trimming adjustment before shipping products, the targeted characteristics may be difficult to obtain in the sensor usage after shipping products. Such a problem is hereinafter simply referred to as “adjustment deviation.”

### SUMMARY OF THE INVENTION

The present invention was made to solve the above-mentioned problems and aims to provide a power supply circuit which is able to prevent the adjustment deviation due to the different operating conditions of the signal processing circuit.

To achieve the above-described object, as one aspect of the present invention, there is provided a power supply circuit supplying voltage to a signal processing circuit processing a signal from a sensor element, both of the senor element and the signal processing circuit being incorporated in a physical quantity sensor and the voltage being provided from outside the sensor, comprising: a control device controlling the voltage so that a total amount of both power consumed by the power supply circuit and power consumed by the signal processing circuit is constant; and an output line outputting power-supply voltage subjected to the control of the control device to the signal processing circuit.

It is preferred that all of the sensor element, the signal processing circuit, and the power supply circuit are incorporated in the physical quantity sensor. In this configuration, for example, the control device is configured to control the total amount of consumed power to be constant by supplying to the signal processing circuit a portion of power provided by the voltage provided from outside the sensor and absorbing a variation in the power consumed by the signal processing circuit by a remaining portion of the power provided by the voltage provided from outside the sensor ((the constant power consumption).

It is also preferred that the power supply circuit further comprises a thermal-connection device connecting the power supply circuit to the signal processing circuit in a heat-transferable manner.

Therefore, even if the signal processing circuit has varied power consumption and increases or decreases its amount of heat generated, such constant power consumption can maintain a constant total amount of the heat generated by the relevant power supply circuit and signal processing circuit. On the other hand, the relevant power supply circuit and signal processing circuit are connected in a heat-transferable manner, so that even if the signal processing circuit generates a varied amount of heat, the relevant power supply circuit increases or decreases its amount of generated heat accordingly, thereby maintaining a constant temperature of the combination of the circuits (the maintenance of the constant temperature of the power supply circuit and signal processing circuit).

It is preferred that the thermal-connection device also connects with the physical quantity sensor in a heat-transferable manner, so that the three components of the relevant power supply circuit, signal processing circuit, and physical quantity sensor are mutually connected in a heat-transferable manner. Thus a constant temperature at the combination of the power supply circuit and signal processing circuit, as well as the relevant physical quantity sensor, can be maintained as described above.

It is also preferred that the thermal-connection device is a semiconductor substrate on which the power supply circuit is configured. For example, either the relevant power supply circuit and signal processing circuit, or, the relevant power supply circuit, signal processing circuit, and physical quantity sensor can be configured on the same semiconductor substrate to easily establish electrical connections thereamong in a heat-transferable manner.

By way of example, the physical quantity sensor is an infrared sensor. This prevents the adjustment deviation due to the different operating conditions of the signal processing circuit which signal-processes the sensor output of the relevant infrared sensor, and the adjustment deviation due to the different operating conditions of the signal processing circuit including the relevant infrared sensor. In addition, for example, the relevant infrared sensor and relevant power supply circuit can be configured on the same semiconductor substrate to relatively easily prevent the adjustment deviation due to the different operating conditions of the signal processing circuit.

### BRIEF DESCRIPTION OF THE DRAWINGS

In the accompanying drawings:

FIG. 1A schematically shows an example of a mechanical configuration of an infrared sensor according to an embodiment of the present invention and schematically shows a plan view of the infrared sensor with a cap removed;

FIG. 1B schematically shows another example of a mechanical configuration of the infrared sensor according to an embodiment of the present invention and shows a cross sectional view taken along line 1B-1B in FIG. 1A;

FIG. 2 shows a circuit diagram of an example of an electrical configuration of the infrared sensor according to the present embodiment; and

FIG. 3 shows a block diagram of a configuration example of the signal processing circuit shown in FIG. 2.

### DETAILED DESCRIPTION OF THE PREFERRED EMBODIMENTS

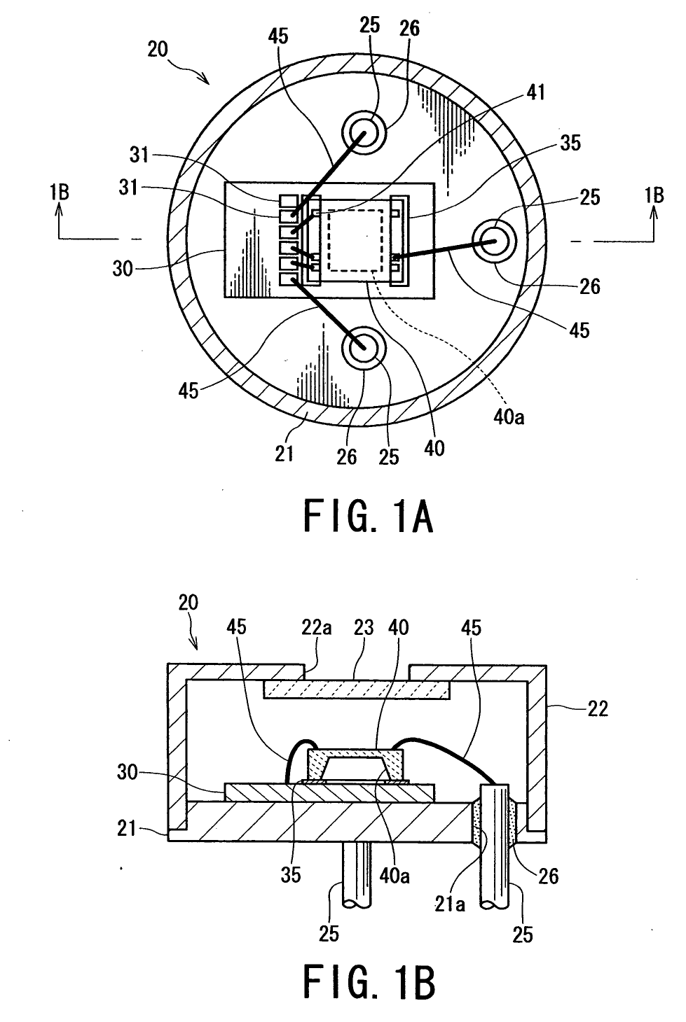

With reference to FIGS. 1A and 1B to 3, an embodiment of the power supply circuit according to the present invention will now be described.

In this embodiment, referring to FIGS. 1A and 1B to 3, a description is given to an example of an infrared sensor 20, in which the power supply circuit according to the present invention is applied to a power supply circuit 55 which supplies drive power to a signal processing circuit 51 of a sensor element 40. Referring to FIGS. 1A and 1B, the mechanical configuration of the infrared sensor 20 is first described.

As shown in FIGS. 1A and 1B, the infrared sensor 20 mainly includes a stem 21, cap 22, filter 23, lead pin 25, semiconductor substrate 30, and sensor element 40, The stem 21 is a disk-shaped member formed by cutting or press working or the like of a metal plate. The stem 21 has one side on which is secured via adhesive or the like the semiconductor substrate 30 which is mounted with a sensor element 40. The stem 21 also has thereon three lead holes 21a, each of which lead pin 25 can pass through.

The cap 22 is a metal plate pressed into a cylindrical shape having a bottom, which shape can cover one side of the stem 21. An opening 22a is provided at almost the center of the bottom, which can act as a receiving window for infrared which is to be detected by the sensor element 40. The opening 22a is closed by the filter 23 made of ceramics or single crystal such as silicon or germanium which is transparent to infrared.

The lead pin 25 is an electric wire rod including copper wire plated by gold or tin. The lead pin 25 is provided passing through the lead hole 21a of the stem 21. A hermetic glass 26 is air-tightly filled and seals between the external wall of the lead pin 25 passing through the lead hole 21a and the internal wall of the lead hole 21a. This allows the interior space of the infrared sensor 20 defined by the stem 21, cap 22, filter 23, lead pin 25, and hermetic glass 26 to contain the semiconductor substrate 30 or sensor element 40 and to fill with nitrogen or inactive gas which absorbs no infrared.

The semiconductor substrate 30 is made of silicon, for example, The semiconductor substrate 30 is sized so that the below-discussed signal processing circuit 51 or power supply circuit 55 or the like can be formed thereon and the sensor element 40 can be mounted thereon, Specifically, the semiconductor-manufacturing process can form on the semiconductor substrate 30 the signal processing circuit 51 which performs a predetermined signal processing for the sensor output from the sensor element 40 mounted on the semiconductor substrate 30, and the power supply circuit 55 which supplies drive power to the signal processing circuit 51, or the like.

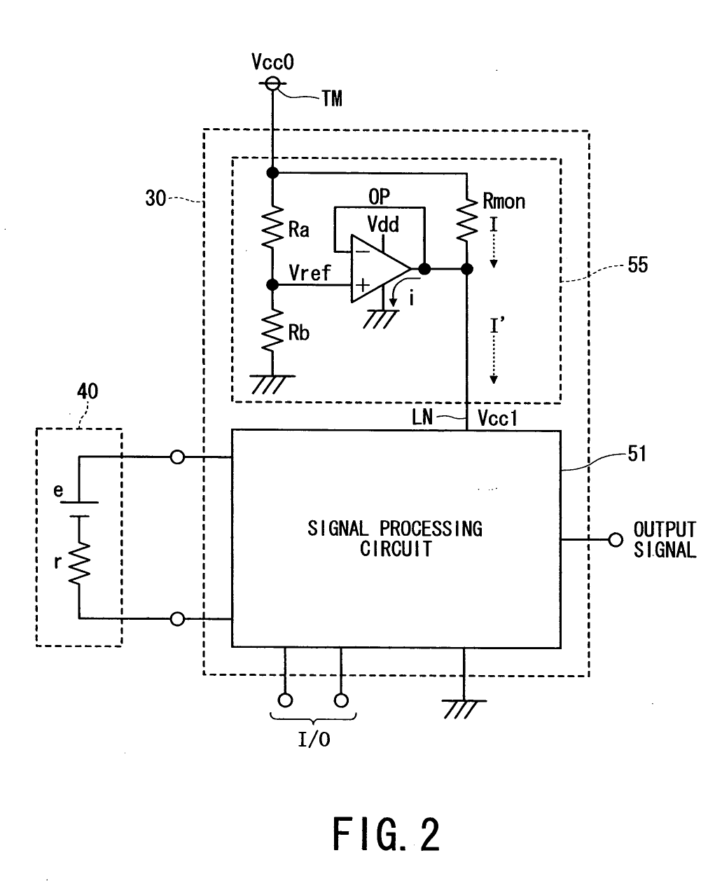

The sensor element 40 is provided with a semiconductor substrate such as silicon, on one side of which a recessed portion 40a is formed to form a membrane portion as a thin-walled portion. The sensor element 40 is, for example, a thermopile-type infrared detection element which sets the thick-walled portion around the membrane portion as the reference point and generates a voltage signal according to the temperature difference between the reference-point temperature and the membrane-portion temperature. The electrical equivalent circuit of the sensor element 40 can thus be expressed as a series circuit including a direct-current voltage source “e” and a resistor “r,” as shown in FIG. 2. Adhesive 35 adhesively secures the sensor element 40 to the semiconductor substrate 30. A wire 45 such as a gold wire electrically connects an electrode 41 of the sensor element 40 with an electrode 31 of the semiconductor substrate 30 or with the lead pin 25. This allows the sensor output from the sensor element 40 to be input via the relevant wire 45 to the signal processing circuit 51 on the semiconductor substrate 30 or to the lead pin 25.

The infrared sensor 20 configured as described above allows the sensor element 40 to receive infrared which enters the cap 22 through the filter 23. The sensor element 40 converts the energy carried by the received infrared into an electrical signal (voltage). The electrical signal is then input as a sensor output into the signal processing circuit 51 or the like of the semiconductor substrate 30 and is output from the lead pin 25 to the outside after receiving a predetermined signal processing.

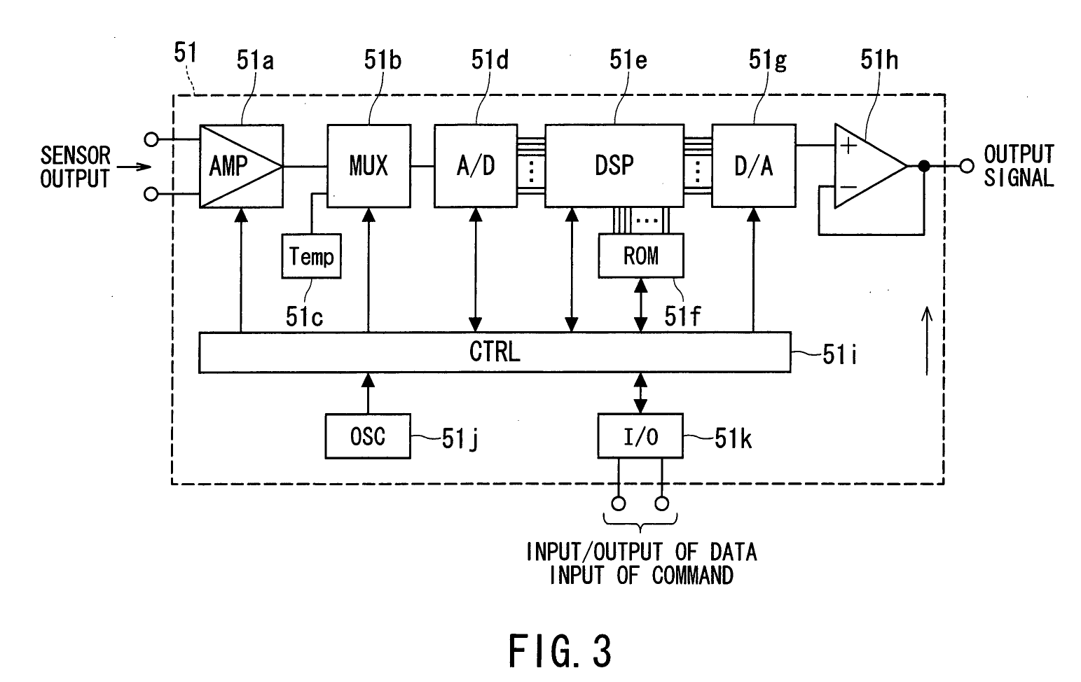

Referring now to FIGS. 2 and 3, the electrical configuration of the infrared sensor 20 will be described. FIG. 2 shows a circuit diagram of an example of the electrical configuration of the infrared sensor 20. FIG. 3 shows a block diagram of the configuration example of the signal processing circuit 51 shown in FIG. 2.

As shown in FIG. 2, the infrared sensor 20 mainly includes, in electrical point of view, a sensor element 40 electrically connected to the semiconductor substrate 30 and both of a signal processing circuit 51 and a power supply circuit 55. In the present embodiment, by way of example, both the circuits 51 and 55 are formed on the semiconductor substrate 30. The power supply circuit 55 and the signal processing circuit 51 are mutually connected by a line LN, so that power-supply voltage (Vcc1 in FIG. 2), which is subjected to control carried out in the circuit 55, is outputted from the power supply circuit 55 to the signal processing circuit 51 via the line LN. The power supply circuit 55 is also connected to a terminal TM receiving predetermined voltage to be inputted from outside the sensor.

The sensor element 40 equals a series circuit including the direct-current voltage source “e” and resistor “r,” as described above. The signal processing circuit 51 is now described below with reference to FIG. 3, which shows its details.

As shown in FIG. 3, the signal processing circuit 51 mainly includes an amplification circuit (AMP) 51a, a multiplexer circuit (MUX) 51b, a temperature-dependent voltage source (Temp) 51c, an A/D converter (A/D) 51d, a digital signal processor (DSP) 51e, a read-only semiconductor memory device (ROM) 51f, a D/A converter (D/A) 51g, an operational amplifier (OP) 51h, a control circuit (CTRL) 51i, an oscillation circuit (0SC) 51j, and an input/output interface circuit (I/O) 51k.

The sensor output is an input from the sensor element 40 as a voltage between the input terminals. The amplification circuit 51a first amplifies the sensor output by a predetermined gain and then inputs it via the multiplexer circuit 51b to the A/D converter 51d. In addition to the amplified sensor output, A/D converter 51d also receives from the multiplexer circuit 51b a temperature-dependent voltage signal input from the temperature-dependent voltage source 51c as a signal to be AD-converted. The A/D converter 51d converts the sensor signal from the analog value into the digital value, and outputs the signal to the digital signal processor 51e. The signal digital processor 51e then reads from ROM 51f a correction data necessary for the relevant sensor signal and performs four operations (predetermined signal processing) of the digital value based on the relevant sensor signal and correction data. Note that the correction data is previously stored in ROM 51f as a correction digital data for the different characteristics of each sensor element 40. This is able to correct the offset, sensitivity, nonlinearity, and the temperature dependency thereof which reside in the sensor element 40 or signal processing circuit 51, thereby providing the highly accurate infrared sensor 20.

Such a type of the signal processing circuit 51 can perform a plurality of samplings for the same sensor signal to provide an averaging process or a digital filter. In this circuit example using the signal processing circuit 51, its output data is an analog voltage value, so that the D/A converter 51g converts the signal to the analog signal, which is then outputted via the voltage follower configured in the operational amplifier 51h. The voltage follower usually serves to compensate the poor current-driving ability of D/A converter 51g itself.

The input/output interface circuit 51k mainly transfers the writing data of ROM 51f. The input/output interface circuit 51k is also used to input commands for the control of operations such as reading the sensor data before adjustment and reading the writing data, or the like. The oscillation circuit 51j generates a clock signal for the digital circuit or the original signal for the clock signal. The control circuit 51i controls the amplification circuit 51a, multiplexer circuit 51b, A/D converter 51d, digital signal processor 51e, ROM 51f, D/A converter 51g, or the like and adjusts their operation timings or the like.

The signal processing circuit 51 as configured above has, in this embodiment, two operation modes: an operation mode “in trimming adjustment before shipping products” (hereinafter referred to as “in-adjustment mode”), and an operation mode “in sensor usage after shipping products” (hereinafter referred to as “in-use mode”). Specifically, in trimming adjustment before shipping products, the signal processing circuit 51 performs a characteristics-measuring process for obtaining sensor outputs under various conditions to obtain the different characteristics data for each sensor element 40. Not-shown another computer or the like analyzes the characteristics data thus obtained to calculate the data which is to be written in ROM 51f as the correction data. The correction data thus calculated is written into ROM 51f via the input/output interface circuit 51k from the outside (for example, not-shown another computer). The in-adjustment mode mainly performs such a characteristics-measuring process and ROM-writing process.

The in-use mode, on the other hand, performs processes such as selecting a plurality of ROMs 51f according to the sensor output from the sensor element 40, then performing a predetermined signal processing by the digital signal processor 51e, and additionally, outputting an analog signal via the voltage follower by the D/A converter 51g and operational amplifier 51h. These two operation modes thus have different positions, different operation speeds, and different operation times at which the circuits operate in the signal processing circuit 51. The signal processing circuit 51 therefore consumes different amount of current and generates different amount of heat accordingly in those two operation modes. Particularly, if the sensor element 40 is mounted on the semiconductor substrate 30 included in the signal processing circuit 51 as in this embodiment, the difference in the amount of heat generated between the two operation modes leads to the difference in the ambient temperature of the sensor element 40 and contributes the “adjustment deviation” as described before. The infrared sensor 20 according to the present embodiment thus has the power supply circuit 55 configured as shown in FIG. 2 which supplies the drive power to the signal processing circuit 51, thereby resolving the above-described “adjustment deviation.” It is noted that the power supply circuit 55 is formed on the semiconductor substrate 30 on which the signal processing circuit 51 is also formed.

Specifically, as shown in FIG. 2, the operational amplifier OP and the resistors Ra and Rb make up a circuit in the power supply circuit 55. This circuit is able to supply a portion of the power input provided as the input voltage Vcc0 at the terminal TM to the signal processing circuit 51 as the power-supply voltage Vcc1 via the resistor Rmon, and is able to control the current I through the resistor Rmon to always be constant regardless of the amount of the current consumption I′ in the signal processing circuit 51. The resistors Ra and Rb thus divide the input voltage Vcc0 to generate the reference voltage Vref which is received by the voltage follower by the operational amplifier OP. The output of the operational amplifier OP connects to the resistor Rmon and the power-supply voltage Vcc1 of the signal processing circuit 51.

The operational amplifier OP thus controls its output to always be the reference voltage Vref using a voltage follower circuit, thereby always providing a constant voltage across the resistor Rmon, thereby providing constant current through the relevant resistor Rmon. The current “I” through the resistor Rmon is, on the other hand, I=(Vcc0−Vref)/Rmon, which divides into current “I′” through the signal processing circuit 51 and current “I” through the operational amplifier OP. Even if, therefore, the current I′ through the signal processing circuit 51 varies, the current i through the operational amplifier OP changes to compensate for the variation of the current I′, so that the amount of current I, the total of the currents (I′+i), remains unchanged.

In this way, the power supply circuit 55, which includes the voltage follower circuit by the operational amplifier OP, and the divider resistors Ra and Rb for generating reference voltage Vref, controls the total of the power consumption of the relevant power supply circuit 55 and the power consumption of the signal processing circuit 51 to be constant by supplying, through the line LN, to the signal processing circuit 51 a portion of the power input as the input voltage Vcc0, and absorbing the variation of the power consumption of the signal processing circuit 51 by the remaining portion of the power input as the input voltage Vcc0.

It is noted that although there are additional currents such as the current through divider resistors Ra and Rb, and the current through the non-inverting input of the operational amplifier OP, these remain constant as long as the input voltage Vcc0 is constant, thereby generating a constant amount of heat. No additional circuits for stabilizing the relevant current are thus necessary. In addition, because the divider resistors Ra and Rb are provided primarily for the reference voltage Vref, they generally have resistor values of dozens of kΩ or more. The input impedance of the operational amplifier OP generally has a very high value of 1 MΩ or more. These components thus generally consume currents of the order of less than a milliampere, and, on the other hand, the signal processing circuit 51 generally draws the current I of the order of a milliampere or more. The divider resistors Ra and Rb or the like may thus generate a negligible amount of heat compared to the amount of heat generated by the signal processing circuit 51. This embodiment thus does not take into account of the current through the divider resistors Ra and Rb or the like.

A description is given here below of the operation of the power supply circuit 55 with reference to specific examples. Assuming, for example, that the input voltage Vcc0 to the power supply circuit 55 is 5.0 V, and the current I′ through the signal processing circuit 51 (hereinafter referred to as the “current consumption I′ of the signal processing circuit 51′”) has 10 mA in the above-described in-adjustment mode and 8 mA in the above-described in-use mode. In addition, the reference voltage Vref is set at 4.7 V, and the relevant resistor Rmon value is set at 25 Ω to have the current I through the resistor Rmon at 12 mA.

If, therefore, the signal processing circuit 51 is in the in-adjustment mode, for example, the signal processing circuit 51 has the current consumption I′ of 10 mA and then the power consumption of 47 mW (=4.7 V×10 mA). The current i through the operational amplifier OP is then the current I through the resistor Rmon (12 mA) minus the current consumption I′ of the signal processing circuit 51 (10 mA), thereby providing the current i=2 mA (−12 mA−10 mA) and the power consumption of 9.4 mW=4.7 V×2 mA. The resistor Rmon has a potential difference of 0.3 V (=5.0V−4.7 V) across it and always carries a current of 12 mA, so that Rmon consumes power of 3.6 mW (=0.3 V×12 mA). If, therefore, the signal processing circuit 51 is in the in-adjustment mode, the signal processing circuit 51 consumes power of 47 mW and the power supply circuit 55 consumes power of 13 mW (=9.4 mW+3.6 mW), so that the whole of the semiconductor substrate 30 consumes power of 60 mW (=47 mW+13 mW).

If, on the other hand, the signal processing circuit 51 is in the in-use mode, for example, the signal processing circuit 51 has the current consumption I′ of 8 mA and then the power consumption of 37.6 mW (=4.7 V×8 mA). The current i through the operational amplifier OP is then the current I through the resistor Rmon (12 mA) minus the current consumption I′ of the signal processing circuit 51 (8 mA), thereby providing the current i=4 mA (=12 mA−8 mA) and the power consumption of 18.8 mW (˜4.7 V×4 mA). The resistor Rmon always carries a current of 12 mA and consumes power of 3.6 mW as described above. If, therefore, the signal processing circuit 51 is in the in-use mode, the signal processing circuit 51 consumes power of 37.6 mW and the power supply circuit 55 consumes power of 22.4 mW (−18.8 mW+3.6 mW), so that the whole of the semiconductor substrate 30 consumes power of 60 mW (=37.6 mW+22.4 mW).

In the specific examples as described above, it is thus understood that regardless of whether the operation mode of the signal processing circuit 51 is the in-adjustment mode or the in-use mode, the whole of the semiconductor substrate 30 consumes power of 60 mW (the constant power consumption). Because of the signal processing circuit 51 and power supply circuit 55 formed on the same semiconductor substrate 30 as described above, the constant power consumption by the whole of the semiconductor substrate 30 regardless of the operation mode of the signal processing circuit 51 can provide a constant amount of heat generated by the semiconductor substrate 30 (the maintenance of the constant temperature of the signal processing circuit 51 and power supply circuit 55). Even if, thus, the signal processing circuit 51 generates a varied amount of heat in the different operation modes, the whole of the semiconductor substrate 30 can generate a constant amount of heat. Even if, therefore, the sensor element 40 is mounted on the semiconductor substrate 30 as in this embodiment, it is possible to maintain a constant ambient temperature of the relevant sensor element 40 to prevent the impact on the temperature characteristics or the like of the sensor element 40. Thus this can prevent the cause of the “adjustment deviation” as described before.

As described above, the power supply circuit 55 for supplying the drive power to the signal processing circuit 51 of the sensor element 40 included in the infrared sensor 20 according to this embodiment is configured so that the resistors Ra and Rb divide the input voltage Vcc0 to generate the reference voltage Vref, which is received by the voltage follower by the operational amplifier OP, and the output of the operational amplifier OP connects to the resistor Rmon and the power-supply voltage Vcc1 of the signal processing circuit 51. The power supply circuit 55 can thus control the total of the power consumption of the relevant power supply circuit 55 and the power consumption of the signal processing circuit 51 to be constant by supplying to the signal processing circuit 51 a portion of the power input as the input voltage Vcc0 and absorbing the variation of the power consumption of the signal processing circuit 51 by the remaining portion of the power input as the input voltage Vcc0. In addition, the signal processing circuit 51 and the power supply circuit 55 are formed on the same semiconductor substrate 30 to make possible the heat transfer with the signal processing circuit 51.

The variation of the power consumption of the signal processing circuit 51 is thus absorbed to control the total of the power consumption of the relevant power supply circuit 55 and the power consumption of the signal processing circuit 51 to be constant (the constant power consumption). Even if, therefore, the signal processing circuit 51 has varied power consumption and increases or decreases its amount of heat generated, such constant power consumption can maintain a constant total amount of heat generated by the relevant power supply circuit 55 and signal processing circuit 51. The relevant power supply circuit 55 and signal processing circuit 51 are, on the other hand, connected in a heat-transferable manner, so that even if the signal processing circuit 51 generates a varied amount of heat, the relevant power supply circuit 55 increases or decreases the amount of generated heat accordingly, thereby maintaining a constant temperature of the combination of the circuits (the maintenance of the constant temperature of the power supply circuit 55 and signal processing circuit 51). This can thus prevent the adjustment deviation due to the different operating conditions of the signal processing circuit 51. It is noted that Rmon may depend on temperature for the purpose of preventing the adjustment deviation. This is because the current I with the temperature dependence can still provide the same amount of heat generated in trimming adjustment and in sensor usage, Accordingly, the foregoing embodiment enables the present invention to have the various advantages which can be summarized as follows.

At first, even if the signal processing circuit has varied power consumption, the variation is absorbed to control the total of the power consumption of the relevant power supply circuit and the power consumption of the signal processing circuit to be constant (the constant power consumption). Even if, therefore, the signal processing circuit has varied power consumption and increases or decreases its amount of heat generated, such constant power consumption can maintain a constant total amount of the heat generated by the relevant power supply circuit and signal processing circuit. The relevant power supply circuit and signal processing circuit are, on the other hand, connected in a heat-transferable manner, so that even if the signal processing circuit generates a varied amount of heat, the relevant power supply circuit increases or decreases the amount of generated heat accordingly, thereby maintaining a constant temperature of the combination of the circuits (the maintenance of the constant temperature of the power supply circuit and signal processing circuit). This can thus prevent the adjustment deviation due to the different operating conditions of the signal processing circuit.

Secondary, a constant temperature at the combination of the power supply circuit and signal processing circuit is maintained as described above, as well as the relevant physical quantity sensor. Hence this is able to prevent the adjustment deviation due to the different operating conditions of the signal processing circuit including the physical quantity sensor.

Third, for example, the relevant power supply circuit and signal processing circuit, or the relevant power supply circuit, signal processing circuit, and physical quantity sensor are configured on the same semiconductor substrate to easily connect them in a heat-transferable manner. Such a configuration thus makes it possible to relatively easily prevent the adjustment deviation due to the different operating conditions of the signal processing circuit.

Fourth, the adjustment deviation is prevented, which is due to the different operating conditions of the signal processing circuit which signal-processes the sensor output of the relevant infrared sensor. Moreover, the adjustment deviation is also prevented, which is due to the different operating conditions of the signal processing circuit including the relevant infrared sensor. In addition, for example, the relevant infrared sensor and relevant power supply circuit can be configured on the same semiconductor substrate to relatively easily prevent the adjustment deviation due to the different operating conditions of the signal processing circuit.

By the way, in FIG. 2 exemplifying the foregoing embodiment, the sensor element 40 has been described such that the sensor element 40 physically separated from the signal processing circuit 51, through being electrically connected to the circuit 51. However this is not a decisive form of the sensor element 40. Some physical quantity sensors include an integrated type of sensor, in which a sensor element is integrated (incorporated) in a signal processing circuit to form a single device, unit, or circuit. Accordingly, the signal processing circuit according to the present invention should be construed to include, in terms of its physical configuration, the sensor element.

The present invention may be embodied in several other forms without departing from the spirit thereof. The present embodiments and modifications as described is therefore intended to be only illustrative and not restrictive, since the scope of the invention is defined by the appended claims rather than by the description preceding them. All changes that fall within the metes and bounds of the claims, or equivalents of such metes and bounds, are therefore intended to be embraced by the claims.

1. A power supply circuit supplying voltage to a signal processing circuit processing a signal from a sensor element, both of the senor element and the signal processing circuit being incorporated in a physical quantity sensor and the voltage being provided from outside the sensor, comprising:
control means controlling the voltage so that a total amount of both power consumed by the power supply circuit and power consumed by the signal processing circuit is constant; and
an output line outputting power-supply voltage subjected to the control of the control means to the signal processing circuit.

2. The power supply circuit according to claim 1, wherein all of the sensor element, the signal processing circuit, and the power supply circuit are incorporated in the physical quantity sensor.

3. The power supply circuit according to claim 2, further comprising thermal-connection means connecting the power supply circuit to the signal processing circuit in a heat-transferable manner.

4. A power supply circuit supplying voltage to a signal processing circuit processing a signal from a sensor element, both of the senor element and the signal processing circuit being incorporated in a physical quantity sensor and the voltage being provided from outside the sensor, comprising:
a control device controlling the voltage so that a total amount of both power consumed by the power supply circuit and power consumed by the signal processing circuit is constant; and
an output line outputting power-supply voltage subjected to the control of the control device to the signal processing circuit.

5. The power supply circuit according to claim 4, wherein all of the sensor element, the signal processing circuit, and the power supply circuit are incorporated in the physical quantity sensor.

6. The power supply circuit according to claim 5, further comprising a thermal-connection device connecting the power supply circuit to the signal processing circuit in a heat-transferable manner.

7. The power supply circuit according to claim 5, wherein the control device is configured to control the total amount of consumed power to be constant by supplying to the signal processing circuit a portion of power provided by the voltage provided from outside the sensor and absorbing a variation in the power consumed by the signal processing circuit by a remaining portion of the power provided by the voltage provided from outside the sensor.

8. The power supply circuit according to claim 6, wherein the thermal-connection device is configured to additionally connect the power supply circuit to the sensor element in the heat-transferable manner.

9. The power supply circuit according to claim 6, wherein the thermal-connection device is a semiconductor substrate on which both the power supply circuit and the signal processing circuit are provided.

10. The power supply circuit according to claim 4, wherein the sensor element is a sensor element for an infrared sensor serving as the physical quantity sensor.

11. A physical quantity sensor comprising:
a sensor element sensing a physical quantity to output a signal corresponding to the sensed physical quantity;
a signal processing circuit processing the signal from the sensor element; and
a power supply circuit providing the signal processing circuit with voltage provided from outside the sensor, wherein the power supply circuit is equipped with a control device controlling the voltage so that a total amount of both power consumed by the power supply circuit and power consumed by the signal processing circuit is constant and an output line outputting power-supply voltage subjected to the control of the control device to the signal processing circuit.

12. The physical quantity sensor according to claim 11, further comprising a thermal-connection device connecting the power supply circuit to the signal processing circuit in a heat-transferable manner.

13. The physical quantity sensor according to claim 11, wherein the control device is configured to control the total amount of consumed power to be constant by supplying to the signal processing circuit a portion of power provided by the voltage provided from outside the sensor and absorbing a variation in the power consumed by the signal processing circuit by a remaining portion of the power provided by the voltage provided from outside the sensor.

14. The physical quantity sensor according to claim 12, wherein the thermal-connection device is configured to additionally connect the power supply circuit to the sensor element in the heat-transferable manner.

15. The physical quantity sensor according to claim 12, wherein the thermal-connection device is a semiconductor substrate on which both the power supply circuit and the signal processing circuit are provided.

16. The physical quantity sensor according to claim 11, wherein the sensor element is a sensor element for an infrared sensor serving as the physical quantity sensor.
